(19) United States
(12) Patent Application Publication
(10) Pub. No.: US 2008/0052398 A1
(43) Pub. Date: Feb. 28, 2008

(54) METHOD, SYSTEM AND COMPUTER PROGRAM FOR CLASSIFYING EMAIL

(75) Inventor: Hisham Emad El-Din Elshishiny, Giza (EG)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/747,954

(22) Filed: May 14, 2007

(30) Foreign Application Priority Data
May 30, 2006 (EP) 06114713.8

(51) Int. Cl. G06F 15/173

(52) U.S. Cl. 709/226

(57) ABSTRACT

Email is classified by generating a fuzzy membership function based on calculated weighted factors related to the persons identified in the “From;”, “To:” and “cc:” fields of the email together with the persons identified in emails already present in the folders of the user's email system. The fuzzy membership function is used to allocate the email to the folder whose emails most frequently identify the persons identified in the email in question, in the roles specified for those persons in the email in question, and based on the distribution of those persons among folders.

### TECHNICAL FIELD

The present invention relates to a method, system and computer program for classifying email on the basis of the persons identified in the email.

### BACKGROUND

Almost all computer users today receive e-mails. Emails typically comprise a “From:”, “To:” and “cc:” section, which identify the persons involved in the email and specify the roles of those persons. In particular, the persons identified in the “From:”, “To:” and “cc:” sections of an email are respectively considered to be the “sender”, “primary recipient(s)” and “secondary recipient(s)” of the email. For simplicity, the “From:”, “To:” and “cc:” sections of an email will be genetically known henceforth as “person fields”

In practice, emails further comprise a “subject” and “message body” section which respectively specify the subject matter and the substantive content of the email. On receipt, emails are collectively housed in a software tool known as an inbox. However, given the increasing number of e-mails received by computer users, emails must be sorted (based on criteria such as subject matter) and organized into repositories (e.g. folders), to facilitate the management of the emails and/or retrieval of information therefrom.

At present, users must organize their emails by manually moving each e-mail to a desired folder. However, this is a time-consuming and tedious process. Therefore, an automatic or semi-automatic tool to help users to classify their e-mail would be very useful. This could take the form of a tool that suggests to the user the folder where the email should be moved. The user can either accept the suggestion or decide to move the email to another folder. The majority of current e-mail classification systems use text-classification techniques such as naive Bayes rule learning and support vector machines to analyze the content of email. However, some e-mail classification systems employ more advanced procedures such as mining temporal patterns or message threads. Similarly, other more advanced email classification systems use sub-graph detection to find patterns that characterize e-mail.

However, traditional text-classification techniques often perform poorly when faced with the problem of email classification because e-mails are typically related to a specific activity (in which some or all of the senders and primary/secondary recipients are involved) whereas traditional documents (for which such text-classification techniques were originally developed) are usually more topic-oriented. Similarly, temporal patterns are not enough to classify emails, as folders may contain messages that arrive at different times.

Malone, T. W. et al. ACM Transactions on Information Systems (TOIS), 5(2), 1987, pp. 115-131 (henceforth known as “Malone et al”) combines ideas from artificial intelligence (AI) (e.g. inheritance and production rules) and user interface (UI) design (e.g. interactive graphical editors). These ideas are applied to semi-structured messages including email, calendars etc., to provide automatic aids for inter alia selecting and sorting messages. However, Malone et al. does not evaluate the contents of emails in users' email folders. Furthermore, Malone et al. does not consider the roles of persons identified in an email.

U.S. Pat. No. 6,606,710 and U.S. Pat. No. 6,947,983 are related to packet data filters and more particularly, the sequence with which rules are applied to data packets. In U.S. Pat. No. 6,606,710, a packet data filter counts the number of times a rule is matched to an incoming data packet, wherein such count is known as a match count. Periodically, the rules are re-ordered so that a rule with a higher match count is moved to an earlier position to the evaluation sequence. During the re-ordering process, the swapping of conflicting rules is prevented. In U.S. Pat. No. 6,947,983, the plurality of filter rules is accorded a priority. The filter rules are arranged into a particular order for testing against a key, wherein the ordering is based on accumulated statistics for each of the plurality of filter rules.

U.S. Pat. No. 5,463,777 relates to a method of processing a binary data packet by examining the information contained in the header portion of the packet. More particularly, the method uses a binary tree search for determining ranges of key elements of the packets and associates with each of the ranges a user supplied data and filter mask.

U.S. Pat. No. 5,463,777, U.S. Pat. No. 6,606,710 and U.S. Pat. No. 6,947,983 either use simple statistics (e.g. counting the number of times rules match an incoming data packet, to facilitate rule re-ordering and prioritizing) or a binary tree search for determining ranges of key elements in a packet. However, these approaches are not similar to considering the roles of the persons involved in an email. Furthermore, these approaches do not provide incremental learning. Similarly, these approaches are not similar to considering the degree of similarity between an email and a folder and discrimination with other folders.

### SUMMARY OF THE INVENTION

The present invention is directed to method and system and computer program for classifying email on the basis of the persons identified in the email as defined in the independent claims. Further embodiments of the invention are provided in the appended dependent claims.

The present invention accurately classifies and sorts e-mails into folders. Furthermore, being computationally efficient, the present invention is suitable for online application. By focusing on the persons identified in emails and their roles therein, the present invention can handle situations in which e-mails are associated with activities performed by people having different roles.

The use of a fuzzy membership function in the present invention enables the invention to embrace the concept that a given e-mail may bear similarities with emails present in several different folders in a user's email system. Finally, the present invention is capable of incremental learning and adaptation with the classification of each e-mail.

### BRIEF DESCRIPTION OF THE DRAWINGS

An embodiment of the invention will now be described with reference to the accompanying Figures in which:

FIG. 1 is a block diagram of an exemplary user's email system; and

FIG. 2 is a flow chart of the method of the present invention.

### DETAILED DESCRIPTION

### Overview

For the sake of simplicity, the method of classifying emails in accordance with the invention will be known henceforth as the email classification method. Furthermore, an email or a folder under consideration will be known henceforth as a studied email or a studied folder respectively.

The email classification method, identifies the persons involved in a studied e-mail from the person fields of the e-mail. If a person identified in a studied e-mail is also identified in any of the emails in a studied folder, the following factors are determined:

(a) the role of the identified person;

(b) the relative frequency with which the person is identified in the emails of the studied folder; and

(c) the number of folders in which the person is identified.

A weight is assigned to each of these factors and a score computed for each person based on the weights. The scores of all the persons involved in a studied email are then summed and transformations applied thereto to construct a novel fuzzy membership function.

The membership function is used to calculate a plurality of fuzzy membership values for a studied email. Each fuzzy membership value is indicative of the similarity of the studied email to emails already present in the folders of the user's email system, wherein the larger the value of a fuzzy membership value, the greater the similarity between a studied email and the emails of a studied folder. Accordingly, the studied e-mail is assigned to the folder corresponding with the highest fuzzy membership value.

### Details

The method of the present invention comprises two operational phases. The first operational phase determines a profile for each of the folders in a user's past classifications of e-mails. The second phase employs the profiles to classify new e-mails. A rescheduling method may be optionally used to reseated the fuzzy membership function and thereby facilitate the coupling of the e-mail classification method with other classification techniques.

### First Phase: Determining Folder Profiles

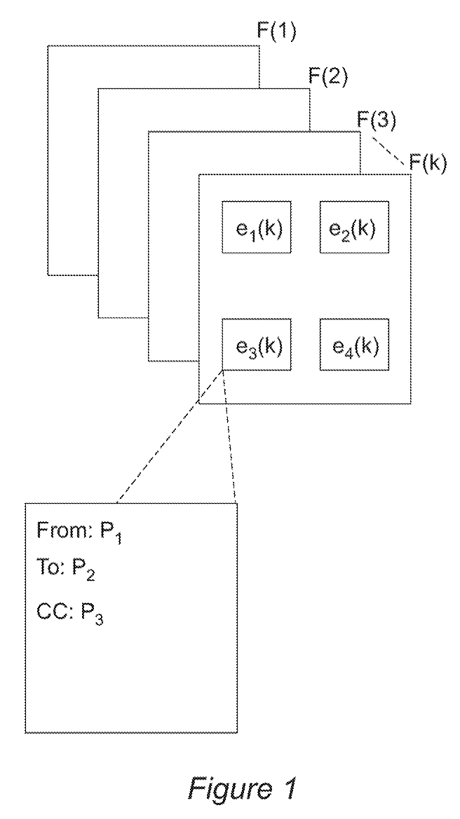

Referring to FIG. 1, let a user's e-mail system comprise k folders F(i) (i=1 to k), wherein each folder F(i) comprises E(i) emails. Let there be m persons P(j) (j=1 to m) appearing in emails in the user's email system, wherein each person P(j) appears in N(j) folders of the user's email system

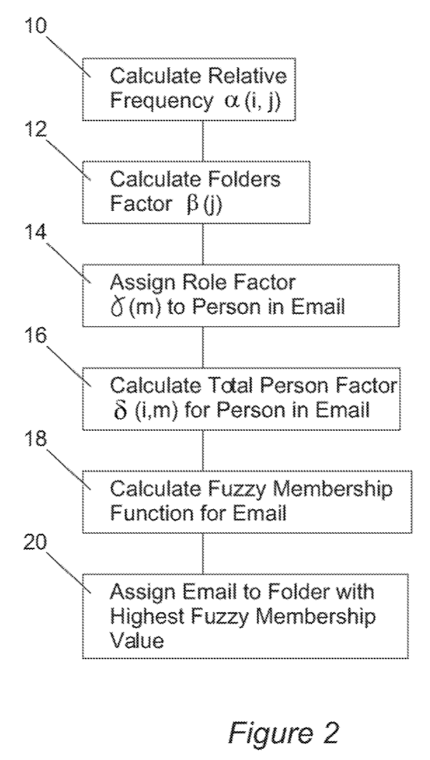

Referring to FIG. 2, let S(j) be the sum of appearances of persons in the emails E(i) of a folder F(i) and let App(i,j) be the number of times in which a particular person P(j) appears in the emails of folder F(i). Thus, the relative frequency α(i,j) with which a person P(j) appears in the emails E(i) of a given folder F(i) can be defined (10) as follows:

$$α ( i , j ) = \frac{App ( i , j )}{S ( i )} \qquad ( 1 )$$

For simplicity, the parameter α(i,j) will be known henceforth as the “relative frequency factor α(i,j)”. Similarly a “folders factor β(j)” may be defined (12) for each person as follows:

$$β ( j ) = \frac{1}{N ( j )} \qquad ( 2 )$$

### Second Phase: Classification of New e-mails

Let there be q persons (excluding the user) P*(n) (n=1 to q) identified in a new studied email E*. Of the q persons, let R(i) also appear in the existing emails in a studied folder F(i) (i=1 to k). According, for each such person P**(t) (t=1 to R(i)) appearing in both the person fields of the studied email and the existing emails in the studied folder F(i):

(a) a “role factor” γ(t) is assigned (14) a value of 1 if the person appears in the ‘From:’ or ‘To:’ sections of the email or a value of 0.5 if the person appears in the ‘cc:’ section of the email;

(b) the relative frequency factor α(i,t) of the person is retrieved from the folder profile;

(c) the folders factor β(t) is retrieved from the folder profile;

(d) a ‘Total Person Factor’ δ(i,t) is calculated (16) as the product of the role factor, relative frequency factor and folders factor, in other words, as

δ(i,t)=β(t)×α(i,t)×γ(t) (3)

The fuzzy membership value φ(i) of the studied email to the studied folder F(i) is defined (18) as the sum of the ‘Total Persons Factors’ values of all the persons (excluding the user) appearing in both the studied email and the existing emails in a studied folder divided by the number of persons appearing in both the email and the existing emails in a studied folder. In other words,

$$δ ( i ) = \frac{{\sum }_{n = 1}^{R ( i )} δ ( i , n )}{R ( i )} \qquad ( 4 )$$

The fuzzy membership value δ(i) has a value in the range of [0,1] and is indicative of the similarity of the studied email with the emails already present in the studied folder. Thus, the set of fuzzy membership values φ(i) (I=1 to k) which is collectively known as the fuzzy membership function Π of the email, provides an indication of the folder in the user's email system whose emails are most similar to the studied email.

The studied email is assigned (2) to the folder associated with the highest value of the fuzzy membership function Π.

After assigning the studied e-mail to a folder, the profiles of the folders are updated (22). Accordingly, the email classification method can incrementally improve its mapping of an email to a folder with the classification of each new e-mail.

The steps of the second phase are repeated for each new email in the user's email system.

### Rescaling the Fuzzy Membership Function

The values of the fuzzy membership function Π can be re-scaled by raising the function to the power of a scaling factor S, wherein S<1. More particularly, S can be calibrated so that the fuzzy membership function Π is likely to attain values of greater than or equal to 0.5 for correctly classified emails. The above calibration of the scaling factor for the fuzzy membership function can be achieved using the equation

S log L=log 0.5 (5)

Referring to equation (5), L is the minimum fuzzy membership value of a correctly classified email obtained after computing the membership function Π for all the emails in each folder of the user's email system.

More particularly, L can be calculated for the omitted email and used to test whether the email classification method assigns the omitted email to the correct folder. The procedure is repeated to omit, in turn, each of the emails in the folder. The membership values for all of the emails correctly assigned to the folder are then accumulated and the minimum membership value calculated therefrom.

This process may be performed during the first phase of the email classification method (i.e. while determining the folders' profiles). It should be noted that this procedure is similar to the leave-one-out cross validation method.

The scaling of the fuzzy membership function Π is particularly useful in cases where a combined inference engine composed of a number of classifiers (all returning values in the range [0, 1] is used to enhance the classification results.

Alterations and modifications may be made to the above without departing from the scope of the invention.

What is claimed is:

1. A method of classifying email comprising the steps of:
comparing a first email with emails in a one or more folders of a user's email system; and
allocating the first email to the folder whose emails are most similar to the first email;
characterized in that
the step of comparing the first email with emails in the folders of a user's email system compares one of one or more persons identified in a person field of the first email with one of one or more persons identified in a corresponding field of the emails in the folders of the user's email system, and
the step of allocating the first email to the folder whose emails are most similar to the first email allocates the first email to the folder whose emails most frequently identify the persons identified in the first email and based on the distribution of the persons identified in the first email among folders of the user's email system.

2. The method of claim 1 wherein
the step of comparing the first email with emails in the folders of a user's email system comprises the step of comparing a one or more roles specified for the persons identified in the first email with roles specified for the persons identified in the emails in the folders of the users email system, and
the step of allocating the first email to the folder whose emails are most similar to the first email allocates the first email to the folder whose emails most frequently identify the persons identified in the first email and specify the same roles for those persons as specified in the first email.

3. The method of claim 1 wherein the step of comparing the first email with emails in the folders of a user's email system comprises the step of generating a fuzzy membership function for the first email, wherein the fuzzy membership function comprises a plurality of fuzzy membership values corresponding with the number of folders in the user's email system and indicates the degree of similarity between the first email and the emails in the folders.

4. The method of claim 2 wherein the step of comparing the first email with emails in the folders of a user's email system comprises the step of generating a fuzzy membership function for the first email, wherein the fuzzy membership function comprises a plurality of fuzzy membership values corresponding with the number of folders in the user's email system and indicates the degree of similarity between the first email and the emails in the folders.

5. The method of claim 4 wherein each of the fuzzy membership values φ(i) (I=1 to k) is given by
$$δ ( i ) = \frac{{\sum }_{n = 1}^{R ( i )} δ ( i , n )}{R ( i )} , wherein \text{:}$$
k is the number of folders in the user's email system;
R(i) is the number of persons identified in both the first email and the existing emails in a studied folder;
$${\sum }_{n = 1}^{R ( i )} δ ( i , n )$$
is the sum of the total person factors (δ(i,n)) for all the persons identified in both the first email and the existing emails in a studied folder; and each total person factor (δ(i,n)) is defined as
δ(i,n)=β(n)×α(i,n)×γ(n)
wherein
β(n) is defined as 1/N(n) and N(n) is the number of folders in the user's email system, in which a one of the one or more persons identified in the first email are identified,
α(i,n) is the relative frequency with which a one of the one or more persons identified in the first email is identified in the emails of a given folder, and
γ(n) is a factor assigned to a one of one or more persons identified in the first email in accordance with the role specified for that person.

6. The method of either one of claims 4 and 5, wherein the step of allocating the first email to the folder whose emails are most similar to the first email further comprises the step of allocating the first email to the folder having the largest fuzzy membership value.

7. The method of claim 6 further including the step of re-scaling the fuzzy membership function by raising the function to a power of S<1.

8. A system for classifying email comprising:
first means for comparing a first email with emails in a one or more folders of a user's email system; and
second means for allocating the first email to the folder whose emails are most similar to the first email;
wherein said first means compares a one or more persons identified in a one or more person fields of the first email with a one or more persons identified in a one or more person fields of the emails in the folders of the user's email system; and
wherein the second means allocates the first email to the folder whose emails most frequently identify the persons identified in the first email and based on the distribution of the persons identified in the first email among folders of the user's email system.

9. The system of claim 8 wherein:
the first means compares a one or more roles specified for the persons identified in the first email with a one or more roles specified for the persons identified in the emails in the folders of the users email system, and
the second means allocates the first email to the folder whose emails most frequently identify the persons identified in the first email and specify the same roles for those persons as specified in the first email.

10. A computer program product comprising a computer usable medium embodying program instructions for classifying email, said program instructions when loaded into and executed by a computer causing the computer to perform a method of comprising the steps of:
comparing a first email with emails in a one or more folders of a user's email system; and
allocating the first email to the folder whose emails are most similar to the first email;
characterized in that
the step of comparing the first email with emails in the folders of a user's email system compares a one or more persons identified in a one or more person fields of the first email with a one or more persons identified in a one or more person fields of the emails in the folders of the user's email system, and
the step of allocating the first email to the folder whose emails are most similar to the first email allocates the first email to the folder whose emails most frequently identify the persons identified in the first email and based on the distribution of the persons identified in the first email among folders of the user's email system.

11. A computer program product as defined in claim 10 wherein:
the step of comparing the first email with emails in the folders of a user's email system comprises the step of comparing a one or more roles specified for the persons identified in the first email with a one or more roles specified for the persons identified in the emails in the folders of the users email system; and
the step of allocating the first email to the folder whose emails are most similar to the first email allocates the first email to the folder whose emails most frequently identify the persons identified in the first email and specify the same roles for those persons as specified in the first email.

12. A computer program product as defined in claim 10 wherein the step of comparing the first email with emails in the folders of a user's email system comprises the step of generating a fuzzy membership function for the first email, wherein the fuzzy membership function comprises a plurality of fuzzy membership values corresponding with the number of folders in the user's email system and indicates the degree of similarity between the first email and the emails in the folders.

13. A computer program product as defined in claim 11 wherein the step of comparing the first email with emails in the folders of a user's email system comprises the step of generating a fuzzy membership function for the first email, wherein the fuzzy membership function comprises a plurality of fuzzy membership values corresponding with the number of folders in the user's email system and indicates the degree of similarity between the first email and the emails in the folders.

14. A computer program product as defined in claim 13 wherein each of the fuzzy membership values φ(i) (I=1 to k) is given by
$$δ ( i ) = \frac{{\sum }_{n = 1}^{R ( i )} δ ( i , n )}{R ( i )} , wherein \text{:}$$
k is the number of folders in the user's email system;
R(i) is the number of persons identified in both the first email and the existing emails in a studied folder F(i);
$${\sum }_{n = 1}^{R ( i )} δ ( i , n )$$
is the sum of the total person factors (δ(i,n)) for all the persons identified in both the first email and the existing emails in a studied folder F(i); and each total person factor (δ(i,n)) is defined as
δ(i,n)=β(n)×α(i,n)×γ(n)
wherein
β(n) is defined as 1/N(n) and N(n) is the number of folders in the user's email system, in which a one of the one or more persons identified in the first email are identified,
α(i,n) is the relative frequency with which a one of the one or more persons identified in the first email is identified in the emails of a given folder, and
γ(n) is a factor assigned to a one of one or more persons identified in the first email in accordance with the role specified for that person.

15. A computer program product as defined in either one of claims 13 and 14, wherein the step of allocating the first email to the folder whose emails are most similar to the first email further comprises the step of allocating the first email to the folder corresponding with the largest fuzzy membership value.

16. A computer program product as defined in claim 15 including additional program instructions for re-scaling the fuzzy membership function by raising the function to a power of S<1.
